(19) United States
(12) Patent Application Publication
(10) Pub. No.: US 2016/0146251 A1
(43) Pub. Date: May 26, 2016

(54) SLIDING SURFACE

(71) Applicant: MAG IAS GMBH, Eislingen (DE)

(72) Inventors: Leo Schreiber, Schwäbisch Gmünd (DE); Jürgen Reingen, Göppingen (DE); Matthias Weber, Bretten (DE); Wolfgang Hafner, Süßen (DE); Emanuel Gross, Lebach (DE); Andreas Grützmacher, Saarlouis (DE)

(21) Appl. No.: 14/779,520

(22) PCT Filed: Mar. 20, 2014
(86) PCT No.: PCT/EP2014/055607

§ 371 Date: Dec. 14, 2015

(30) Foreign Application Priority Data
Mar. 25, 2013 (EP) 13160919.0
Aug. 21, 2013 (DE) 10 2013 109 043.5

(51) Int. Cl. F16C 33/10

(52) U.S. Cl. CPC F16C 33/1075; F16C 33/107

(57) ABSTRACT

It is proposed according to the invention for structuring of straight bearing surfaces (1) with microscopically small indentations (27) in particular produced by electro chemical material removal to limit the surface portion of the indentations to 15% to 40% of the entire structured surface since this reduces manufacturing complexity whereas a larger surface portion with indentations (27) hardly generates any further reduction of friction in the straight bearing.

### I. FIELD OF THE INVENTION

The invention relates to a sliding surface of a tribological pairing, in particular a straight bearing surface of a radial bearing, in particular bearings of a crankshaft in an internal combustion engine, on one side relative to an engine block and on another side relative to connecting rods.

### II. BACKGROUND OF THE INVENTION

In sliding surfaces of a lubricated tribological pairing it is essential for an amount of sliding friction and also for a service life of the tribological pairing, in particular of the straight bearing that a sufficient amount of lubricant is provided in all operating conditions and that the lubricant is evenly distributed between contact surfaces of the tribological pairing. Thus, a beginning of a relative motion between both sliding surfaces is particularly critical.

An increasing use of stop systems in motor vehicles increases the criticality of the beginning of the relative movement, in particular for bearings of a crankshaft since this increases a number of start processes of the straight bearings by a factor of one hundred or more.

Therefore contact surfaces of sliding surfaces, in particular of straight bearings are processed so that they have very small indentations with a depth of significantly below 100 μm which are used as reservoirs for lubricants. These indentations are provided due to a natural roughness of the material of the sliding surface or they are introduced in a controlled manner. Therefore the ratio of contact area of a sliding bearing, thus the surface portion of the contact surfaces that actually are in contact with each other is always significantly below 100%, partially even below 60%.

A respective structuring of the sliding surfaces is achieved by special processing steps like grinding, finishing, or honing for which, however, an actual shape and distribution of the recesses cannot be predetermined and also a variation with respect to size, in particular depth of the indentations is rather large. In particular the result of the structuring is highly dependent from an experience of an operator.

In order to achieve a defined structuring of the contact surfaces of a straight bearing with respect to number, size, depth and distribution of the indentations it is also known to impact the surface with a laser in order to obtain the desired indentations.

This method, however, has a disadvantage in that it is very time consuming for a large number of indentations. Furthermore the impacting laser beam does not only generate an indentation on the surface, but also an annular bell mouth surrounding the indentation which is undesirable in many applications and which requires another finishing step for removing the bell mouth. Typically a shape of flanks of the indentation generated by the laser is hardly controllable.

Another advantage is that laser processing generates strong heating in a small three dimensional area and subsequent fast cooling leads to undesirable hardness zones. Furthermore a machining method of electro chemical milling is known (ECM) which can also be used in a pulsed manner (PECM).

This way three dimensional surfaces are fabricated, for example three dimensional surfaces of coins, or the described indentations are introduced into surfaces wherein typically only a removal of 30 μm at the most is economically viable when preformed with this method.

Approaching an accordingly configured electrode with a negative contour towards the surface to be processed which acts as another electrode removes material from the surface in the form of ions. This process yields a much finer contour than electrical discharge machining.

For current conduction and removing dissolved materials a current conducting liquid is pressed through the gap between tool and work piece during the entire process.

When the work pieces are crankshafts, in particular crankshafts for car engines with a high number of cylinders an additional disadvantage is that these crankshafts are instable during processing and thus difficult to position and that it is also difficult to structure these work pieces.

Dimensional precision of a finished crankshaft is primarily determined by assessing the following parameters in addition to maximum bearing width:
Diameter deviation=maximum deviation from a predetermined nominal diameter of the bearing pin,
Circularity=macroscopic deviation from a circular nominal contour of the bearing pin determined by a distance of an outer enveloping circle and an inner enveloping circle,
Concentricity=radial dimensional deviation for a rotating work piece caused by a eccentricity of the rotating bearing and/or a shape deviation of the bearing from an ideal circular shape
Roughness defined by the mean single depth of roughness Rz=a computed value representing the microscopic roughness of the bearing,
Contact percentage=contacting surface portion of the microscopic surface structure which is in contact with a contacting opposite surface, and additionally for crank pin bearings:
Stroke deviation=dimensional deviation of the actual stroke (distance of an actual center of the crank pin from the actual center of the crank journal) from the nominal stroke, and
Angular deviation in degrees or stroke related longitudinal deviation in circumferential deviation of the actual angular position of the crank pin from its nominal angular position relative to the central bearing axis and with respect to the angular position to the remaining crank pins.

Thus, maintaining the desired tolerances for these parameters is limited by the available machining methods and also by the instability of the work piece and the machining forces.

Efficiency and economics of a processing method are of great importance for practical applications, in particular for series production where cycle time and thus production cost is of great importance, whereas these limitations do not apply for a processing of test samples of prototypes.

This applies in particular for the last process steps when manufacturing for example a crankshaft, finishing and surface structuring, in particular of their bearings.

With respect to a size and distribution of indentations on the structured surface it is known from WO 2011 044 979 and also from DE 10 2006 060 920 to vary size and surface portion of indentations produced in cylinder bores along the piston travel, in particular to provide more and larger indentations at the dead centers than in a center portion of the piston travel.

### III. DETAILED DESCRIPTION OF THE INVENTION

### a) Technical Task

Thus, it is an object of the invention to propose a structured sliding surface and a method and a tool for producing the sliding surface which provides efficient fabrication while significantly reducing friction, in particular in a hydro dynamic straight bearing.

### b) Solution

This object is achieved by the features of claim 1, advantageous embodiments can be derived from the dependent claims.

In practical applications it has become apparent that an optimum ratio between complexity and utility is achieved when between 15 and 40%, better between 15% and 30%, even better between 20 and 30% of the surface are covered with indentations in the structured portion. A higher percentage of indentations does not yield any further improvement of sliding properties, but significantly increases manufacturing complexity and has other disadvantages.

Even in cases where only highly loaded portions are structured in a sliding surface that is unevenly loaded it has proven advantageous to select the surface portion within indentations within the structured portion larger in the more highly loaded portion than in the less loaded portion.

It has also proven advantageous within the structured portion to select the indentations smaller in the portion with the highest loading and/or to select the smallest distance between two adjacent indentations smaller than in portions with lower loading within the structured portion.

Thus it has also proven useful that a largest extension of an individual indentation in top view is at least 20 μm, better at least 50 μm, better at least 70 μm, however there is a sensible upper limit of this largest extension of at least 170 μm, better at least 150 μm, better at least 120 μm beyond which the sliding properties are not changed positively any further.

By the same token there is a particularly effective range of a depth of these indentations which have a particular beneficial effect when the depth is at least 2 μm, better at least 10 μm, better at least 20 μm, but does not exceed 50 μm, better does not exceed 35 μm, better does not exceed 20 μm.

Furthermore a sensible upper limit for a small extension of an indention in top view has become apparent, namely 150 μm at the most, better 100 μm, better 50 μm at the most.

It has become furthermore apparent that the largest extension of the indentation shall have 10× the size of the smallest extension of the indentation at the most, better 5× the extension at the most, even better 3× the extension at the most.

Furthermore a favorable ratio between a depth of the indentation and a largest extension of the indentation in top view has become apparent.

The depth of the indentations should be at least 1%, better at least 5%, better at least 20%, better at least 40%, and better at least 50% of this largest extension.

Furthermore it has proven advantageous when a smallest distance between two adjacent indentations is at least two times, better at least three times, better at least five times the largest extension in top view of the two indentations involved and at the most seven times, better at the most times of the largest extension in top view of the two indentations involved.

Furthermore slanting a flank of the indentation that is oriented against the direction of movement of the sliding surface, the so called runout flank along which the lubricant is pulled out of the indentation during operation of the tribological pairing has proven significant.

Its angle relative to the surface should not be greater than 80° at the most, better 45° at the most, better 30° at the most, better 25° at the most, simultaneously this angle should be at least 45°, better at least 60°.

It has become furthermore apparent that in particular a rotation symmetrical straight bearing which has circumferential portions with maximum loading of the straight bearing and portions with minimum loading the straight bearing surface should be structured differently in these portions namely even when the sliding surface is only structured partially, namely in the portions that are loaded more highly.

Thus, the indentations in the portion of the highest loading should be deeper at least by a factor of two, better by a factor of three, better by a factor of five, than in the portion of the lowest loading.

It has also proven useful to provide a runout flank over which the lubricant is pulled out of the indentation steeper in the portion of the highest loading, than in the portion of lowest loading, thus at least by 10%, better at least by 15%, even better at least 20% steeper.

Furthermore, the configuration of the indentations, and in particular the determination of their depth has to take the radial extension of the mechanical bearing gap into account, thus the distance of the sliding surfaces predetermined by the configuration.

It has become apparent in practical applications that the depth of the indentations should be at the most 0.5 times, better at the most 0.3 times, even better at the most only 0.1 times the dimension of the bearing gap.

Even the greatest extension of the indentations viewed in top view should be 14 times at the most, better 8 times at the most, and even better 4 times at the most the radial extension of the mechanical bearing gap.

### c) Embodiments

Embodiments of the invention are subsequently described in more detail with reference to drawing figures, wherein:

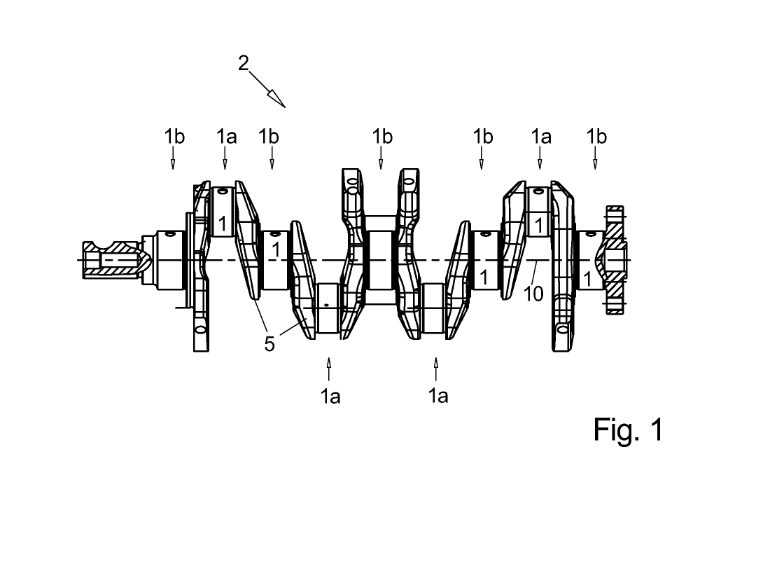

FIG. 1 illustrates a crankshaft for a four cylinder internal combustion engine in a lateral view;

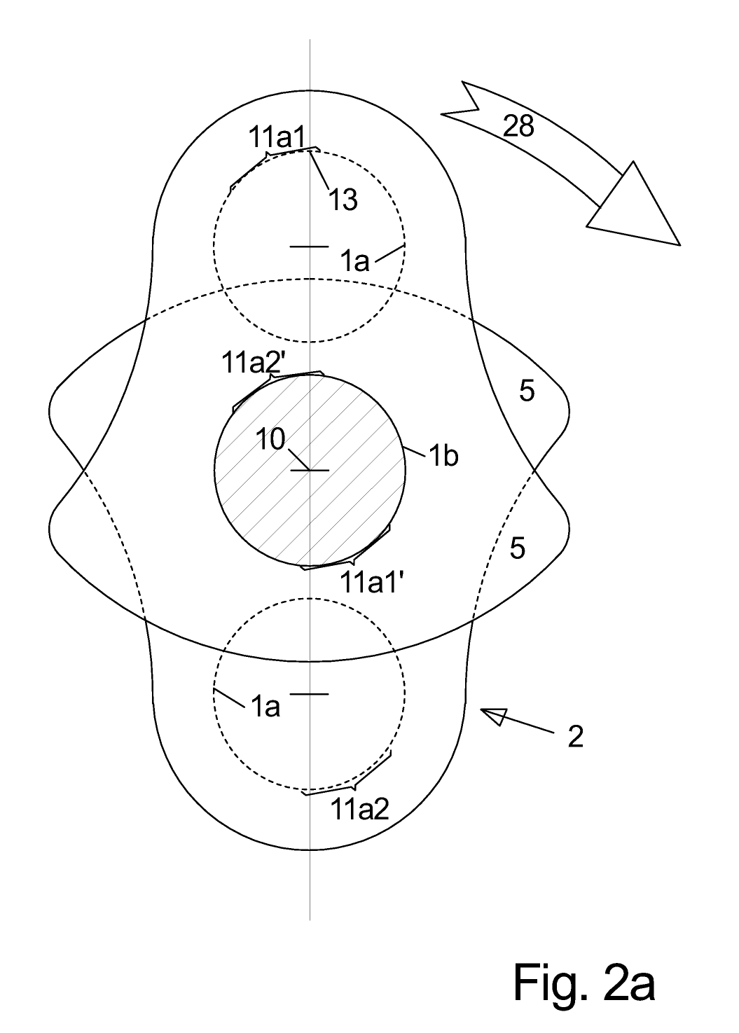

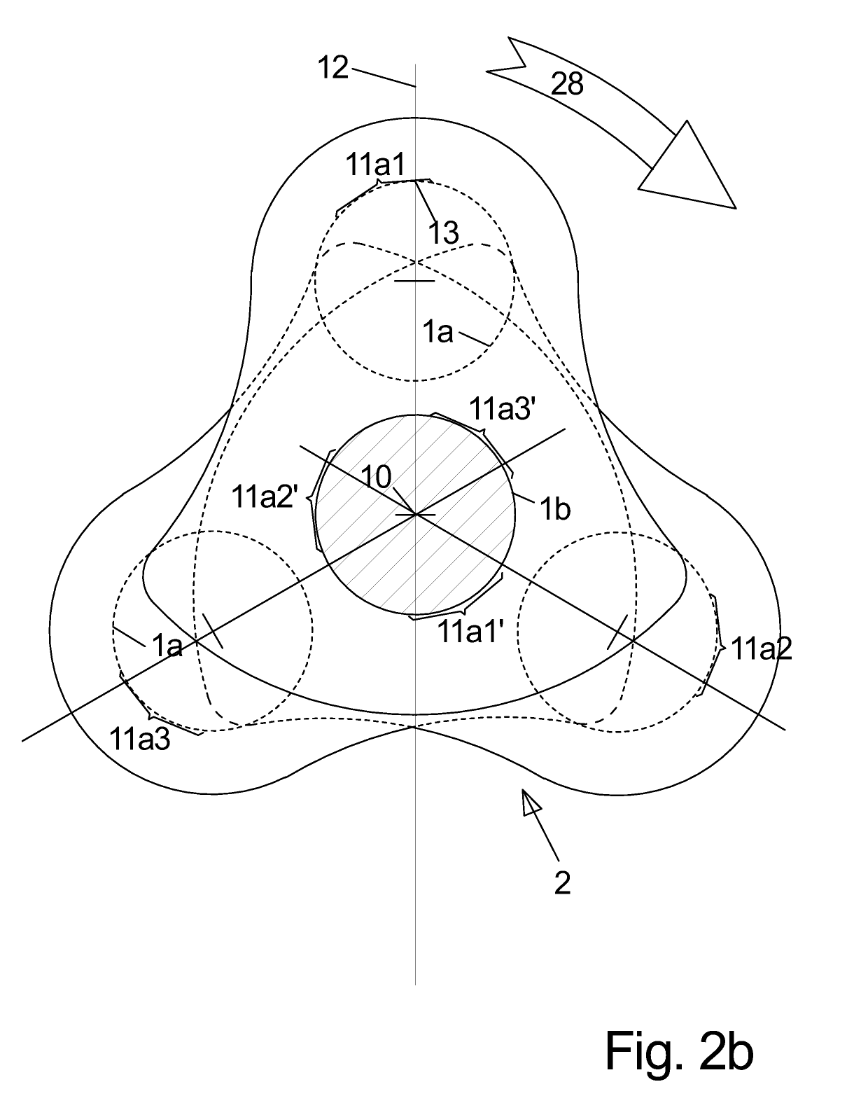

FIG. 2a illustrates the crankshaft of FIG. 1 in an axial viewing direction sectioned through one of the center bearings;

FIG. 2b illustrates a crankshaft for a six cylinder internal combustion engine in an axial viewing direction sectioned through a center bearing;

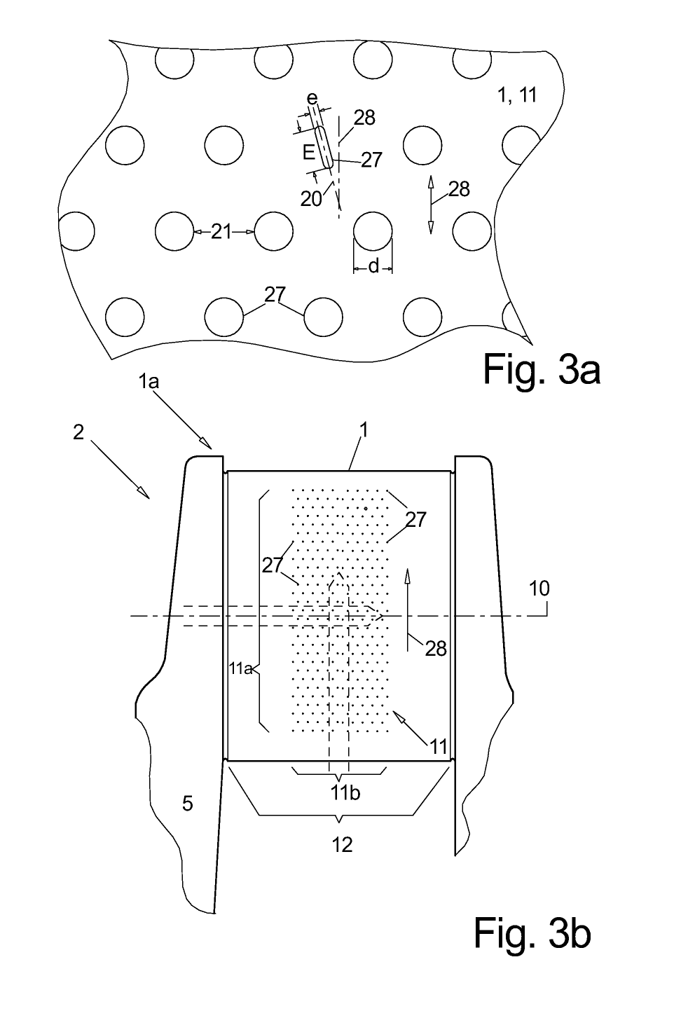

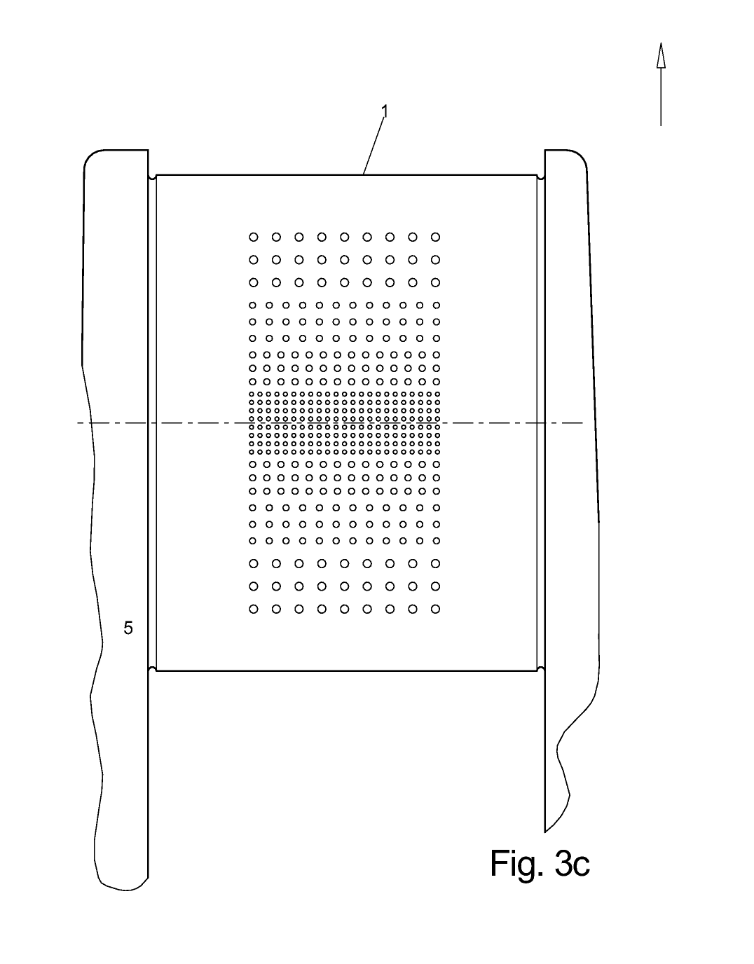

FIG. 3a illustrates a top view of a structured portion of a sliding surface;

FIG. 3b illustrates a detail view of a bearing of a crankshaft;

FIG. 3c illustrates another detail view of a bearing of a crankshaft; and

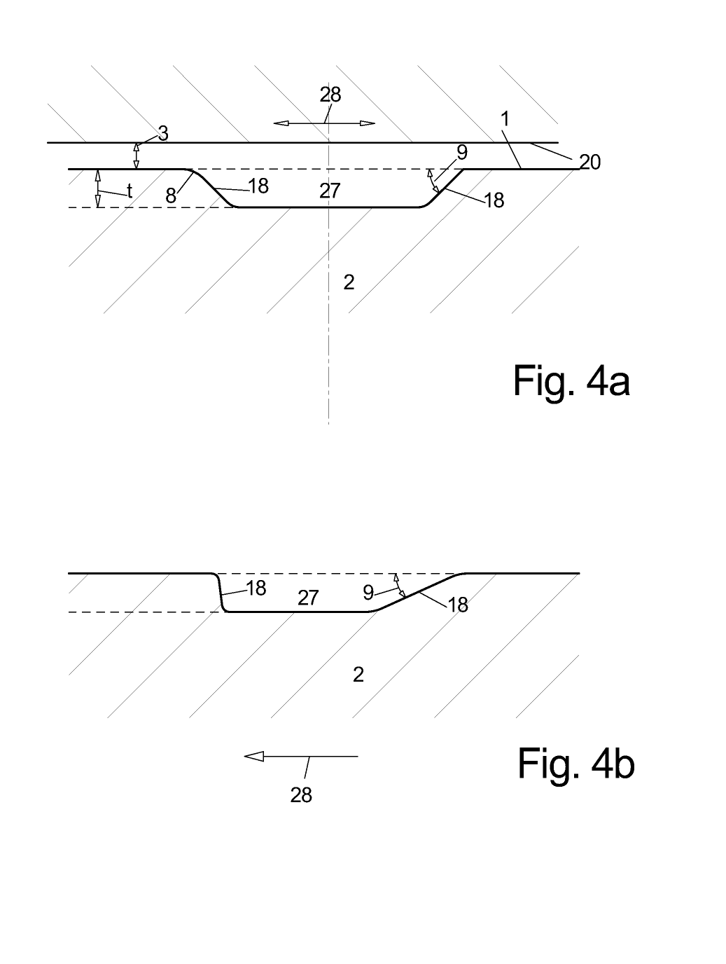

FIG. 4a, b illustrate sectional views of indentations in the sliding surface.

FIG. 1 illustrates a typical work piece at which sliding surfaces 1 shall be structured with indentations for friction reduction, thus a crankshaft 2 for a four cylinder reciprocating engine in a side view wherein a total of five center bearings 1b with an approximately enveloping cylindrical surfaces are provided on the subsequent rotation axis 10 of the crankshaft, wherein the center bearings have approximately cylindrical enveloping surfaces forming sliding surfaces 1. Between these center bearings 1b respective outward offset crank bearings 1a are provided to form crank bearings wherein the crank bearings respectively have a proximal cylindrical bearing surface forming a sliding surface for a respective associated connecting rod wherein the crank bearings are connected with the center bearings by lobes 5.

Already from this illustration it is apparent that a crankshaft 2 of this type which is only supported e.g. in a turning machine at its axial ends during machining is a rather instable work piece due to its structure and easy bendability in its center portion in particular when machining precisions and approaching of tools in a range of a few μm are at issue.

Friction in a hydro dynamic straight bearing in which a lubricant, typically oil is arranged between two sliding surfaces of the tribological pairing, wherein the lubricant is distributed over the sliding surface through the relative motion of the sliding surfaces and forms a sliding film in the bearing gap facilitates reducing friction when indentations 27 are introduced into the sliding surface 1 as illustrated in FIG. 3a in a top view of sliding surface 1 and in FIG. 4a in a sectional view.

Electro chemical manufacturing (ECM) is used in order to produce such indentations in the p-range with defined shape, size, depth, and distance from each other in a reproducible manner and economical manner in a large number.

According to the invention only a respective portion 11 of a bearing 1a, 1b of the crankshaft 2 is structured, thus in a circumferential direction of the bearings as illustrated in FIGS. 2a and b.

For the illustrated crankshafts for a four cylinder (FIG. 2a) or a six cylinder reciprocating engine (FIG. 2b) the highest operational load is applied to the crankpin 1a at the point in time when the gas mix is ignited and in the short time period thereafter in which the combustion pressure builds up in the cylinder and accelerates the piston downward. The non illustrated connecting rod the presses onto the circumferential portion 11a1 of the crank bearing 1a which is currently on top and whose center is arranged in the rotation direction 28 of the crankshaft 2 behind a point 13 of this crank pin 1a wherein the point 13 is the furthest away from the rotation axis 10 of the crankshaft.

Since the bearing shell of the current connecting road is not supported punctiform, but over a particular circumference range at the crank pin, the most highly loaded circumferential portion 11a1 is a portion which may even begin shortly before the radially outermost point 13 and which extends over an angular segment against the rotation direction 28 wherein the angular segment extends e.g. over 60°.

For the other crank pin 1a this is an analog portion when the crank pin is in its highest position.

The pressure imparted by the connecting rod is primarily transferred to the respective crank pin and from there through the lobes 5 also at least onto the two axially adjacent center bearing pins 1b and to a lesser extent also onto the axially further remote center bearing pins 1b which are pressed with the circumferential portion 11a1′ into their respective bearing shell through the pressure of the connecting rod on the side that is opposite to the circumferential portion 11a1.

Therefore the circumferential portions 11a1′, 11a2′ of the center bearing pin 1b that are arranged respectively diametrically opposite to the two circumferential portions 11a1 and 11a2 are highly loaded portions as well.

Thus, only the highly loaded circumferential portions 11a of a bearing are structured or structured more than the rest of the bearing, advantageously however only these portions are structured in order to be able to save processing of the remaining portions.

Using a six cylinder crankshaft as an example it is drawn into FIG. 2b that the circumferential portions 11a1′, 11a2′, 11a3′ that are arranged opposite to all highly loaded portions 11a1, 11a2, 11a3 of all crank pins are structured in all center bearing pins 1b, though only circumferential portions that are arranged opposite to both axially adjacent crank pins could be structured.

This is based on the idea that also the load on the further remote crankpins can load the respective center bearing pin more highly in the respective circumferential portion.

FIG. 3b furthermore illustrates that only the center width portion 11b of the bearing 1 is structured transversal to the movement direction 28, thus in the axial direction 10.

This is sufficient in many cases, in particular when the bearing surface 1 is not shaped cylindrical, but slightly convex, namely the smallest bearing gap during operations, thus the greatest risk of the bearing seizing, is incurred in the tribological pairing with a cylindrical bearing shell in a center portion of its axial extension.

As illustrated in FIG. 3b either the entire width of the bearing 1 in axial direction or only an axial center portion of the bearing 1 is structured according to the invention, optionally in addition to the structuring that is also provided in circumferential direction, optionally only in portions.

Thus, the sliding surface is provided with a plurality of very small indentations 27 in the structured portion as illustrated in the enlarged top view of FIG. 3a since it has become apparent that structuring in portions already significantly reduces friction.

These indentations 27 are configured for example circular in top view or also elongated, for example configured as a short groove with semicircular ends with a smallest extension e and a largest extension E and a respective smallest distance 21 as illustrated in FIG. 3a.

The surface portion of the indentations 27 within the structured portion 11 should thus be in a range of 15% to 40% of the entire surface of the structured portion 11.

A distance 21 from center to center between two adjacent indentations 27 should thus be at least three times, better at least five times, better at least seven times the largest extension E of the indentation in top view.

Advantageously the indentations 27 are arranged in a uniform pattern, for example in a diamond pattern, whose one diagonal is arranged in the circumferential direction 28.

For elongated indentations 27 their main extension 20 should be arranged primarily in the circumferential direction 28 of the bearing 1, thus the subsequent rotation direction and should be arranged at an angle of 30° at the most relative thereto. The indentations 27 should not be elongated to much either, namely the maximum extension E should be at the most ten times the size, better only three times the size of the smallest extension e which is also illustrated in FIG. 3a.

As illustrated in FIG. 3c an optimum cost benefit ratio can be reached in the structured portion by a variation of sizes and distances of the indentations 27 within the structured portion.

In this figure the indentations 27 are the smallest and have the smallest distance 21 from each other in the most highly loaded portion, namely in circumferential direction about the drawn symmetry line.

In the circumferentially adjacent less loaded second portion the indentations 27 are much larger in top view, their distance, however, is larger as well so that optionally a respective choice of the distance covers a larger or also a slightly smaller surface portion of the structured surface with indentations 27.

By the same token the third portion that is even further remote from the symmetry line and even loaded less is provided with even greater indentations 27 which compared to the first portion for example have three times the diameter, whereas the diameter in the second portion is twice the diameter. Also in this third portion the surface portion that is covered by the structured surface with indentations 27 can be the same or can be smaller than in the first in and in the second portion.

It has furthermore become evident that also a shape and a size of the indentations 27 is very important for reaching the goal as illustrated in the sectional views of FIG. 4a, b.

Namely the indentations shall have a depth t in the μm range since this reduces the load bearing capability by the least amount and still causes a sufficient depot effect and thus a reduction of friction.

Compared to the depth t of the indentations 27 the indentations 27 can have a smallest extension e, for example for circular indentations 27a diameter d of 150 μm at the most, or even only 50 μm.

In FIG. 4a, b the shape of the flanks 18 of the indentations 27 shall be illustrated.

In a vertical sectional view as illustrated in FIG. 4a the indentations can be symmetrical, in particular rotation symmetrical, thus the flanks 18 can have the same slant angle 9 relative to the surface of the bearing 1.

In addition and/or instead the flank 18 shall transition into the surface of the bearing 1 with a radius 8 of at least 2 μm as illustrated in FIG. 4a at the left flank. Both measures help that lubricant received in the indentations 27 during operation of the crankshaft can be transported away easily in the circumferential direction 28 through the adhesion at the contact surface of the bearing block, thus the opposite surface 20 relative to the sliding surface 1 so that the lubricant can be transported into the bearing gap 3 remote from the indentations 27.

Therefore the bearing gap 3 should be smaller than the depth t of the indentations 27 preferably the bearing gap should be less than 0.5 times the depth of the indentations.

As illustrated in FIG. 4b it is not disadvantageous either to configure the flank 18 steeper which flank is arranged in the subsequent rotation direction of the crankshaft 2 since the lubricant is only transported in the opposite direction. Thus, the volume of the individual indentations 27 is increased without a negative influence so that a depot effect is improved.

Due to the recited lower depth t of the indentations 27 which furthermore also develop their full effect without a controlled introduction of connections between the indentations it has become apparent that the roughness of the surface of the bearing 1 has to be in a range in the surface portions between the indentations 27, wherein the range is below the depth t of the indentations 27.

These portions between the indentations shall also have a sufficient percentage of contact area of for example 60% to 70%.

### REFERENCE NUMERALS AND DESIGNATIONS

1 bearing, sliding surface
1a crank bearing surface, crank bearing
1b center bearing surface, center bearing
2 crankshaft, work piece
3 bearing gap
4 fluid, electrolyte
5 lobe
8 radius
9 angle
10 axial direction, rotation axis
11 structured portion, partial portion
11a circumferential portion
11b Width portion
12 total width
13 radially outermost point
18 flank
20 opposite surface
21 distance
27 indentation
28 movement direction, rotation direction
d diameter
e smallest extension
E largest extension
T depth

1. A sliding rotation symmetrical straight bearing surface (11) for a sliding movement along an opposite surface (20), wherein the surface of the sliding surface (1) is structured by geometrically defined very small indentations (27) with a predetermined distribution, characterized in that in a structured portion (11) a surface portion of a surface that is provided with the indentations (27) is between 15% and 40% of the total surface of the structured portion.

2. The sliding surface according to claim 1, characterized in that in a structured portion (11) with uneven loading in the portion of a highest loading of the sliding surface (1) a surface portion of a surface covered with indentations (27) is greater than in the portion of the lower loading.

3. The sliding surface according to claim 1, characterized in that for a structured portion (11) with uneven loading in a portion of the highest loading of the sliding surface (1), the indentations (27) are smaller and/or a smallest distance (21) between two adjacent indentations (27) is less than in the portion of the lower loading.

4. The sliding surface according to claim 1, characterized in that in top view of the sliding surface (1) a largest extension (E) of an indentation (27) is at least 20 μm.

5. The sliding surface according to claim 1, characterized in a top view of the sliding surface (1) the largest extension (E) of an indentation (27) being 170 μm at the most, better 150 μm at the most.

6. The sliding surface according to claim 1, characterized in that
in top view a smallest extension (e) of the indentation (27) is 150 μm at the most,
and/or
in top view the largest extension (E) of the indentation (27) is at the most 10 times the size of the smallest extension (e).

7. The sliding surface according to claim 1 characterized in that a depth (t) of the indentations (27) is at least 2 μm.

8. The sliding surface according to claim 1 characterized in that the depth (t) of the indentations (27) is at the most 50 μm.

9. The sliding surface according to claim 1 characterized in that a depth (t) of the indentations (27) is at least 1% of a largest extension (E) in top view of the indentation (27).

10. The sliding surface according to claim 1, characterized in that a smallest extension (21) between two adjacent indentations (27) is at least 2× of the largest extension (E) in top view of the indentation (27).

11. The sliding surface according to claim 1 characterized in that a smallest distance (21) between two adjacent indentations (27) is at the most 7× of the largest extension (E) in top view of the indentation (27).

12. The sliding surface according to claim 1, characterized in that in a sectional view in a relative movement direction (28) of the sliding surface (1), in particular in a circumferential direction (28) of a rotation symmetrical surface (1) of the indentations (27), an outlet flank (18) of the indentation (27) which is oriented opposite to the movement direction (28) of the sliding surface (1) is steeper than the opposite flank, in particular at an angle 9 of 80° at the most, at the most relative to the surface between the indentations (27).

13. The sliding surface according to claim 1, characterized in that in a sectional view in a relative movement direction (28) of the sliding surface (1), in particular in a circumferential direction (28) of a rotation symmetrical surface (1) of the indentations (27), an outlet flank (18) of the recess (27) oriented against the movement direction (28) of the sliding surface (1) is inclined an angle (9) of at least 45° relative to the surface between the indentations (27).

14. The sliding surface according to claim 1, characterized in that for a sliding surface (1) with uneven loading in the portion of the strongest loading of the sliding surface (1) an angle (9) of the outlet flank (18) of the indentations (27) is greater in than in the portion with the lower loading.

15. The sliding surface according to claim 1 characterized in that
in a sliding surface (1) with uneven loading in the portion of the highest loading of the sliding surface (1) the indentations (27) are deeper in particular by at least by a factor of 2 than in the portion of the lowest loading of the structured portion.
and/or
in the portion of the highest loading the outlet flank (18) is steeper, in particular at least 10% steeper than in the circumferential portion of the lowest loading of the structured portion.

16. The sliding surface according to claim 1, characterized in that for a sliding surface (1) a depth (t) of the indentations (27) is at the most 0.5 times the depth of the mechanical bearing gap (3).

17. The sliding surface according to claim 1 characterized in that for a sliding surface (1) the largest extension (E) of the indentations (27) is at the most 14 times the extension of the mechanical bearing gap (3).
